(19) United States
(12) Patent Application Publication
(10) Pub. No.: US 2003/0165105 A1
(43) Pub. Date: Sep. 4, 2003

(54) Data memory

(76) Inventors: Jorn Leiber, Hamburg (DE); Bernhard Mussig, Seevetal (DE); Stefan Stadler, Hamburg (DE)

Correspondence Address: NIXON & VANDERHYE, PC, 1100 N GLEBE ROAD, 8TH FLOOR, ARLINGTON, VA, 22201-4714, US

(21) Appl. No.: 10/297,439

(22) PCT Filed: May 21, 2001
(86) PCT No.: PCT/EP01/05834

(30) Foreign Application Priority Data
Jun. 7, 2000 (DE) 100-28-113.3

(51) Int. Cl. G11B 7/00

(52) U.S. Cl. 369/110.01; 369/121; 369/283

(57) ABSTRACT

The inventive data memory (1) has an optically writeable and readable information carrier, which has a polymer film (11) whose refractive index can be locally altered by heating. An absorber is assigned to the polymer film (11) and is disposed for at least partially absorbing a write beam and for transferring, in an at least partially local manner, the heat generated thereby to the polymer film (11). The absorber is oriented in order to preferably absorb light with a polarization direction that is matched to the orientation of the absorber.

The invention relates to a data memory with an optically writeable and readable information carrier.

DE 298 16 802 U1 discloses a data memory with an optically writeable and readable information carrier which comprises a polymer film, whose refractive index can be locally altered by heating. When the polymer film is locally heated with the aid of a write beam, the change of the refractive index leads to a change of the reflecting power (reflectivity) at the relevant position. This can be used for the storage of information. In order to read the information, a read beam is used which is reflected more strongly from positions with increased reflectivity, and this can be measured in order to pick up the information. The polymer film, which, for example, consists of polymethyl methacrylate or polypropylene, may be prestressed (stretched) in both surface directions during production, so that a high internal energy is stored in the material. Under local heating by the write beam, if the polymer film is configured in this manner, a pronounced material change (densification) takes place as a result of return deformation and the refractive index is changed in the desired way. In the previously known data memory, the polymer film may be assigned an absorber (for example a dye), which preferentially absorbs the write beam and locally delivers the heat thereby produced to the polymer film. With the aid of an absorber, it is possible to achieve a sufficiently large change of the refractive index (for example a change of about 0.2) even with a relatively low intensity of the write beam.

The information is read by reflection, so that the read beam has to cover two times as long a path in the storage medium compared with the write beam during the write process. Furthermore, the reflectivity change is only of the order of 1% when the refractive index changes by 0.2, for example. Especially during reading, the absorber therefore causes considerable problems, in particular when the information carrier has multiple plies, and there is a risk that the read beam detector will no longer receive sufficient power.

It is an object of the invention, in the case of a data memory of the aforementioned type, to provide a way of being able to use the advantages of an absorber for the write process, but without having to tolerate the disadvantages for the read process.

This object is achieved by a data memory having the features of claim 1. Advantageous configurations of the invention are given in the dependent claims. Claim 16 relates to the use of such a data memory in a drive suited to it.

The data memory according to the invention has an optically writeable and readable information carrier which comprises a polymer film, whose refractive index can be locally altered by heating. The polymer film is assigned an absorber which is designed to absorb a write beam at least partially and to locally deliver the heat thereby produced at least partially to the polymer film. According to the invention, the absorber is arranged in an oriented fashion in order to preferentially absorb light with a polarization direction matched to the orientation of the absorber.

During writing of information with the aid of a polarized write beam, whose polarization direction is matched to the orientation of the absorber—or more precisely to the orientation of the transition dipole moment of the absorber, it is hence possible to achieve high absorption and therefore effective local heating of the polymer film, in order to change its refractive index. If the read beam is polarized in a direction that is rotated in relation to the polarization direction of the write beam, and is advantageously perpendicular to it, the read beam is attenuated by the absorber only to a comparatively small extent, or virtually not at all, so that reliable reading of the data from the information carrier is possible with little outlay and low intensity.

The polymer film is advantageously stretched, for example by prestressing it in two mutually perpendicular directions within its plane during production. The effect of this is that a high energy density is stored in the film material. By depositing a comparatively small quantity of energy per unit area with the aid of a write beam, it is then possible to obtain a pronounced material change (for example material densification) by return deformation, which results in a local change of the refractive index and a change of the optical path length in the material. The change of the refractive index, in the region which is locally heated by the write beam, is advantageously of the order of 0.2, which leads to a change of the local reflectivity that can be picked up well with the aid of the read beam.

In the polymer film, the information units are formed by changing the optical properties in a region with a preferred size of less than 1 μm. In this case, the information may be stored in binary form, i.e. the local reflectivity takes only two values. This means that, for example, a “1” is stored at the relevant position on the information carrier when the reflectivity lies above a set threshold value, and a “0” is correspondingly stored when it is below this threshold value, or below another lower threshold value. It is, however, also conceivable to store the information in a plurality of gray levels. This is possible if the reflectivity of the polymer film can be deliberately altered locally in a defined way, but without reaching saturation, and this can be achieved, for example, with the aid of a biaxially oriented polypropylene film.

In a preferred configuration of the invention, the polymer film contains absorber. In this case, the absorber contained in the polymer film is advantageously oriented by stretching the polymer film in a preferential direction. To that end, during production of the polymer film, absorber molecules may be introduced into the film compound and aligned during the stretching process, so that, in statistical terms, the transition dipole moments of the absorber molecules have a preferential direction. If the polymer film is stretched in two directions, it may possibly need to be stretched more strongly in one direction after introduction of the absorber molecules, in order to achieve the desired orientation of the absorber.

It is also conceivable for a layer, which contains absorber, to be arranged on the polymer film. This layer may, for example, be an adhesion layer for joining together polymer film plies that are arranged above one another (see below). Configurations in which both the polymer film itself and the layer arranged on the polymer film contain the absorber are likewise possible. The absorber is advantageously introduced into such a layer in an oriented fashion.

In a preferred configuration of the invention, the absorber comprises dye molecules whose transition dipole moments are arranged oriented in a preferential direction. The dye molecules advantageously have a high absorbing power in the spectral range used for the write beam. The write beam is advantageously polarized parallel to the transition dipole moment of the dye molecules, while the polarization direction of the read beam is advantageously perpendicular to it.

The data memory according to the invention may, in principle, have an information carrier with a polymer film which is arranged in a single ply. In a preferred embodiment of the invention, however, the information carrier comprises a plurality of polymer film plies, through which information units can be written to a preselected polymer film ply or read from a preselected polymer film ply. A high storage density is achieved in this way. By focusing the write beam and the read beam onto the preselected polymer film ply, information can be written to this polymer film ply and read from it, respectively, in a controlled way. During the write process, the write beam is defocused in the polymer film plies neighboring the relevant polymer film ply, so that the neighboring polymer film plies are locally heated only slightly, and the information stored there is not altered.

The absorber assigned to different polymer film plies may, in one configuration of the invention, be oriented in different directions. In this case, during the write process, a preselected polymer film ply can be addressed in a more controlled way by optimizing the polarization direction of the write beam in relation to the orientation of the absorber in the preselected polymer film ply, so that maximum absorption takes place there. In the polymer film plies neighboring the preselected polymer film ply, however, the write beam is absorbed only to a small extent (besides the fact that it is defocused there).

Advantageously, an adhesion layer is respectively arranged between neighboring polymer film plies; it may, for example, comprise a bonder (for example an acrylate bonder) and it optionally contains absorber. The polymer film plies can be bonded to one another with the aid of the adhesion layers.

It is advantageous for the refractive index of the adhesion layer to differ only slightly from the refractive index of the polymer film. This is because reflection takes place at any interface between two layers with different refractive indices, and in the present case this would attenuate the intensities of the write beam and the read beam. On the other hand, the differences between the refractive indices of the polymer film plies and of adhesion layers may be used for formatting the data memory. Advantageously, the difference between the refractive indices of polymer film plies and of adhesion layers is so small that the reflection at the interface is less than 4%, or more preferably less than 1%. A particularly advantageous situation can be achieved if the refractive index difference is less than 0.005.

In a preferred embodiment of the invention, the information carrier is wound spirally. In this way, it is possible to achieve a multi-ply structure of the data memory with the aid of a single polymer film, which permits a high storage density and a large storage capacity. In this case, the data memory advantageously has an optically transparent winding core, which is designed to accommodate a write and read device of a drive suited to the data memory. The drive may have a write and/or read head, which is moved, in the interior of the transparent winding core, relative to the data memory which is stationary, or in which the write and/or read beam is/are directed into the data memory via moving optical elements. Because the data memory itself is stationary in this case, it does not need to be balanced with a view to a fast rotational movement.

Preferred materials for the polymer film are biaxially oriented polypropylene (BOPP) or polymethyl methacrylate (PMMA) with typical film thicknesses of from 10 μm to 100 μm, for example approximately 50 μm or approximately 35 μm. Such film thicknesses ensure that the information items on neighboring polymer film plies can be separated from one another at good resolution with the aid of drives such as are known in principle, for example, from DVD technology. Other materials for the polymer film are likewise conceivable.

An acrylate bonder, for example, may be used for an adhesion layer, the layer thickness typically being between 1 μm and 40 μm, and small layer thicknesses being preferred.

A suitable absorber should be matched to the spectral properties of the write beam. Advantageously, the write beam and the read beam are emitted by a laser, an identical laser or the same laser being used for the write beam and the read beam. Pulsed operation of the laser is suitable for the write beam, and a continuous-wave mode is suitable for the read beam. Wavelengths of 630 nm or 532 nm are currently standard; technical progress is tending toward shorter wavelengths, since a higher storage density can be achieved with them. Examples of suitable absorbers include the dye Disperse Red 1 (DR1), an azo dye, which is used in applications of nonlinear optics in polarized polymer films. DR1 also has the advantage that the transition dipole moment lies in the direction of the molecule axis. Other absorbers are likewise possible.

The invention will be explained in more detail below with reference to examples. In the drawings,

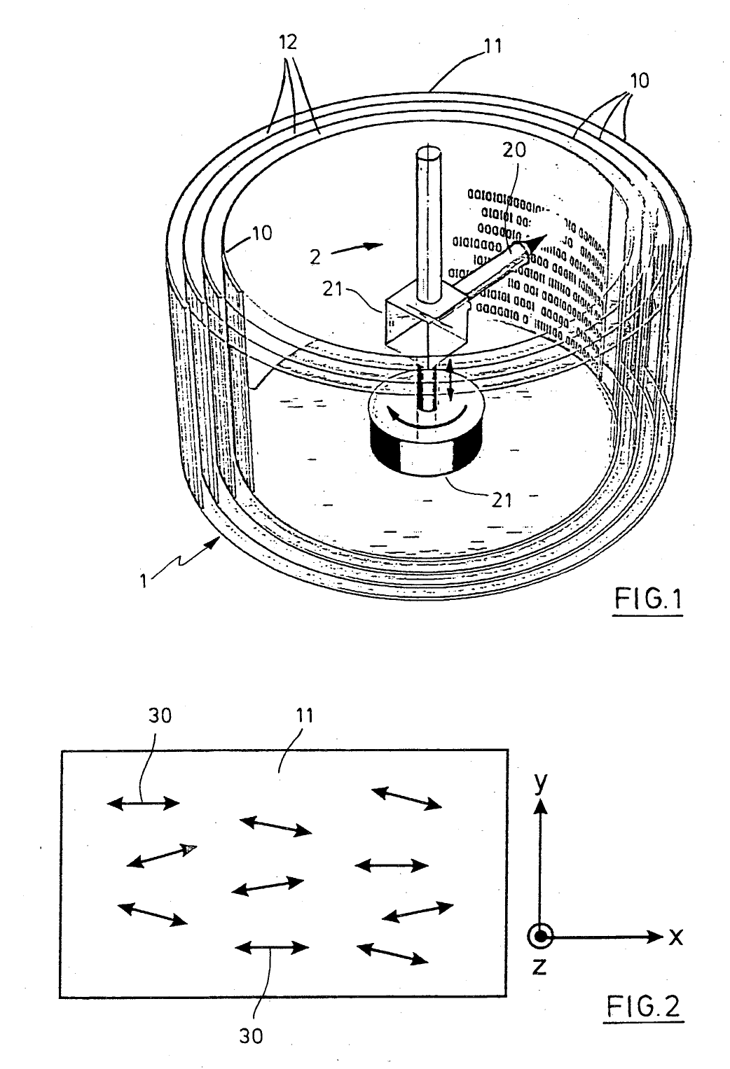

FIG. 1 shows a data memory according to the invention, which comprises a spirally wound information carrier and a winding core, in a schematic perspective representation, with parts of a drive suited to the data memory being arranged inside the winding core, and

FIG. 2 shows a schematic representation of the orientation of dye molecules that are used as the absorber in the data memory according to the invention.

FIG. 1 shows, in a schematic representation, a data memory 1 and a write and read device 2 of a drive suited to the data memory 1. The data memory 1 comprises a number of plies 10 of a polymer film 11 which is used as an information carrier and is wound spirally on an optically transparent winding core. For the sake of clarity, the sleeve-shaped winding core is not shown in FIG. 1; it lies inside the innermost ply 10. For clearer illustration, the individual plies 10 of the polymer film 11 are shown as concentric circular rings in FIG. 1, although the plies 10 are formed by spirally winding the polymer film 11. An adhesion layer 12 is respectively arranged between neighboring plies 10 of the polymer film 11. For reasons of clarity, the adhesion layers 12 have been indicated in FIG. 1 with a thickness that has been enlarged in a way which is not true to scale.

In the exemplary embodiment, the polymer film 11 consists of biaxially oriented polypropylene and has been prestressed in both surface directions prior to winding. In the exemplary embodiment, the polymer film 11 has a thickness of 35 μm; other thicknesses in the range of from 10 μm to 100 μm, or even thicknesses lying outside of this range, are likewise conceivable. The adhesion layers 12 are free from gas bubbles and, in the exemplary embodiment, they consist of acrylate bonder with a thickness of 23 μm, preferred layer thicknesses being between 1 μm and 40 μm. In the exemplary embodiment, the data memory 1 contains twenty plies 10 of the polymer film 11, and it has an external diameter of about 30 mm. The height of the winding cylinder is 19 mm. A different number of plies 10, or different dimensions, are likewise possible. The number of turns or plies 10 may, for example, be between 10 and 30, although it may also be more than 30.

An absorber in the form of dye molecules is introduced into the polymer film 11 during or after production; when the polymer film 11 is stretched, they become statistically aligned, in a similar way to the production of polarization films, in such a way that their transition dipole moments are oriented in a preferential direction. This is explained in more detail below.

The write and read device 2 arranged in the interior of the winding core contains a write and read head 20, which, with the aid of a mechanism 21, can be rotated in the directions of the indicated arrows and moved axially to and fro. The write and read head 20 comprises optical elements, with the aid of which a light beam (for example with the wavelength 630 nm or 532 nm) produced by a laser, which is not shown in FIG. 1, can be focused onto the individual plies 10 of the polymer film 11. Since the write and read head 20 is moved with the aid of the mechanism 21, it can fully scan all the plies 10 of the data memory 1. In the exemplary embodiment, the data memory 1 is in this case stationary. It does not therefore need to be balanced with a view to a fast rotational speed, in contrast to the write and read head 20. For the sake of clarity, the elements intended to balance the write and read head 20 are not shown in FIG. 1. Said laser lies outside the write and read head 20 and is stationary; the laser beam is guided into the write and read head 20 via optical elements.

In order to store or write information in the data memory 1, the laser is operated with a beam power of about 1 mW in the exemplary embodiment. The laser beam is in this case used as a write beam, and it is focused onto a preselected ply 10 of the polymer film 11 so that the beam spot is smaller than 1 μm, the light energy being input in the form of short pulses with a duration of about 10 μs. The write beam is polarized, its polarization direction being aligned parallel with the transition dipole moment of the dye molecules of the absorber in the preselected ply 10. The energy of the write beam is therefore absorbed optimally in the beam spot, which leads to local heating of the polymer film 11 and hence to a local change of the refractive index and of the reflectivity.

In order to read stored information from the data memory 1, the laser is operated in the continuous-wave mode (CW mode), the laser beam used as the read beam likewise being polarized, but in a polarization direction that is rotated through 90° in relation to the write beam. The read beam is therefore virtually unattenuated by the absorber in the individual plies 10 of the polymer film 11, and it can pass unhindered to the position at which it is focused. The read beam is reflected as a function of the stored information, and the intensity of the reflected beam is picked up by a detector in the write and read device 2.

FIG. 2 illustrates the orientation of the polarization directions and of the transition dipole moment of the dye molecules of the absorber. The transition dipole moments of the dye molecules, denoted by 30, in the polymer film 11 are arranged in an oriented fashion, and specifically, in the representation according to FIG. 2, statistically in a preferential fashion parallel to the x-axis, as indicated by the double arrows. The polarization direction of the write beam likewise runs parallel to the x-axis, while the polarization direction of the read beam is perpendicular to it, and specifically parallel to the y-axis.

There are various methods for producing a polymer film with an oriented absorber. A review can be found in J. Michl and E. W. Thulstrup, “Spectroscopy with Polarized Light”, VCH Publishers Inc., New York, 1986, in section 3.1.3. The options for introducing absorber molecules into the film material are basically (i) pouring a polymer film from a solution that contains the polymer and absorber molecules, and subsequently evaporating the solvent, (ii) swelling a polymer film in a solution having absorber molecules, and subsequently evaporating the solvent, (iii) diffusing absorber molecules in the vapor phase into a polymer film and (iv) dissolving the dye molecules in molten polymer. All four methods are suitable for a polymer film made of polypropylene, method (ii) being preferred. If suitable absorber molecules are introduced into an as yet unstretched polymer film, and the polymer film is subsequently stretched, the absorber molecules become oriented so that they preferentially absorb light with a polarization direction matched to the orientation of the absorber molecules.

The absorber Disperse Red 1 (DR1) is suitable for a polymer film made of polypropylene. DR1 is an azo dye which is approximately stick-shaped and can therefore be oriented very well. This dye is known from applications with polarized polymer films containing dyes in nonlinear optics. DR1 may be introduced into a polymer film which has been stretched only in one direction, and which is subsequently stretched in the other direction, or into an unstretched polymer film, which is subsequently stretched biaxially, but to a different degree in the two directions. The desired alignment of the absorber molecules is obtained in both cases.

If, according to method (iv), the absorber is intended to be introduced into molten polypropylene, in which case temperatures of the order of 200° C. are encountered, absorbers with higher thermal stability, for example anthraquinone dyes or indanthrene dyes, are more suitable than DR1.

In the exemplary embodiment explained above, the polymer film 11 made of biaxially oriented polypropylene contains the absorber DR1 in a concentration such that an optical density of 0.2 is obtained with the indicated film thickness of 35 μm. The optical density at the light wavelength of the write beam is advantageously in the range of from 0.1 to 0.3 for a polymer film ply, although it may also be smaller or greater.

The optical density is a quantity that is very suitable for characterizing the absorption behavior. The following applies for the optical density D:

D=log(1/T)=ε_{λ}cd

Here, T=I/I₀ is the transmission through a layer of thickness d, with the intensity of the incident radiation being reduced from I₀ to I, ε_{λ} is the extinction coefficient at the wavelength λ being used (concentration-independent substance parameter), and c is the concentration of the absorber.

Other materials are likewise conceivable for the polymer film. For example, polyethylene terephthalate (PET) may be used, also in conjunction with the absorber dye DR1.

1. A data memory with an optically writeable and readable information carrier which comprises a polymer film (11), whose refractive index can be locally altered by heating, and with an absorber (30) which is assigned to the polymer film (11) and is designed to absorb a write beam at least partially, and to locally deliver the heat thereby produced at least partially to the polymer film (11), wherein the absorber (30) is arranged in an oriented fashion in order to preferentially absorb light with a polarization direction matched to the orientation of the absorber (30).

2. The data memory as claimed in claim 1, characterized in that the polymer film (11) is stretched.

3. The data memory as claimed in claim 1 or 2, characterized in that the polymer film (11) contains absorber (30).

4. The data memory as claimed in claim 3, characterized in that the absorber (30) contained in the polymer film (11) is oriented in a preferential direction by stretching the polymer film (11).

5. The data memory as claimed in one of claims 1 to 4, characterized in that a layer (12), which contains absorber, is arranged on the polymer film (11).

6. The data memory as claimed in one of claims 1 to 5, characterized in that the absorber (30) comprises dye molecules whose transition dipole moments are arranged oriented in a preferential direction.

7. The data memory as claimed in one of claims 1 to 6, characterized in that the information carrier comprises a plurality of polymer film plies (10), through which information units can be written to a preselected polymer film ply (10) or read from a preselected polymer film ply (10).

8. The data memory as claimed in claim 7, characterized in that the absorber (30) assigned to different polymer film plies (10) is oriented in different directions.

9. The data memory as claimed in claim 7 or 8, characterized in that an adhesion layer (12), which optionally contains absorber, is respectively arranged between neighboring polymer film plies (10).

10. The data memory as claimed in claim 9, characterized in that the adhesion layer (12) has a bonder.

11. The data memory as claimed in claim 9 or 10, characterized in that the refractive index of the adhesion layer (12) differs only slightly from the refractive index of the polymer film (11).

12. The data memory as claimed in one of claims 7 to 11, characterized in that the information carrier is wound spirally.

13. The data memory as claimed in claim 12, characterized by an optically transparent winding core, which is designed to accommodate a write and read device (2) of a drive suited to the data memory (1).

14. The data memory as claimed in one of claims 1 to 13, characterized in that the polymer film (11) comprises biaxially oriented polypropylene.

15. The data memory as claimed in one of claims 1 to 14, characterized in that the absorber (30) comprises the dye Disperse Red 1.

16. The use of a data memory as claimed in one of claims 1 to 15 in a drive suited to it, wherein for writing information to a preselected polymer film ply (10), a polarized write beam is used whose polarization direction is matched for preferential absorption, preferably maximum absorption, in the oriented absorber (30) assigned to this polymer film ply (10), and wherein for reading information from this polymer film ply (10), a polarized read beam is used whose polarization direction is rotated, preferably through 90°, with respect to the polarization direction of said write beam.
